(19) United States
(12) Patent Application Publication
(10) Pub. No.: US 2002/0183665 A1
(43) Pub. Date: Dec. 5, 2002

(54) Back-mountable massage device

(76) Inventor: Jeong-Joo Suh, Seoul (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/957,386

(22) Filed: Sep. 19, 2001

(30) Foreign Application Priority Data
May 31, 2001 (KR) 2001-30351

(51) Int. Cl. A61H 7/00

(52) U.S. Cl. 601/84

(57) ABSTRACT

A massage device includes a supporting cover having a main body and a shoulder supporting member connected to the main body, a shoulder massage part provided to the shoulder supporting member, and a driving part for driving and controlling the shoulder massage part. The supporting cover is designed to be put on the human body by a belt

### BACKGROUND OF THE INVENTION

1) Field of the Invention

The present invention relates to a massage device, and more particularly, to a massage device that can knead the human body such as the neck and shoulders in a state where it is mounted on the back, thereby obtaining a finger-pressure therapy effect while saving a massaging space.

2) Description of the Related Art

Generally, a massage device is used to obtain selected stroking, rubbing and/or kneading massaging effects of the human body to increase the blood flow and obtain muscle relaxation.

A body massage may be divided into three levels of rising intensities. The first level, known in the art as stroking, involves a smoothing action characterized by mild to medium pressure applied onto a body part being massaged. Stroking is meant to warm-up and thereby prepare the body part being massaged to the following massage levels. The second level, known in the art as rubbing, involves a pressing and rubbing action characterized by movement of the tissue and medium to high pressure applied on the body part being massage. Rubbing is meant to increase the blood flow in the body part being massaged. The third level, known in the art as kneading, involves a pressing and kneading actions characterized by high pressure applied onto the body part being massaged. Kneading is typically a deep and through muscle massage extends over a relatively prolonged time minutes or more.

Such massage devices may be categorized into a vibration-type massage device and a kneading/rubbing-type massage device. The vibration-type massage is designed to convert a rotation movement of a motor into a vibration movement of a massage head. The kneading/rubbing-type massage device is designed to convert a rotation movement into a rubbing/kneading movement of a massage element.

Generally, such a vibration-type massage device is a hand-held type so that the user can held and locate the device on a body part to be massaged. However, the vibration-type massage cannot sufficiently provide the massage effect as it repeats its vibration.

In addition, such a rubbing/kneading-type massage device should be associated with a body supporting apparatus such as a chair or bed such that the user can use it in a state where the user's body is located and stuck onto the body supporting apparatus. Therefore, the conventional rubbing/kneading-type massage device has a problem that the body part to be massage is limited to a specific part such as the waist and the back that can be located on the body supporting apparatus.

### SUMMARY OF THE INVENTION

Therefore, the present invention has been made in an effort to solve the above-described problems.

It is an objective of the present invention to provide a rubbing/kneading-type back-mountable massage device that can be used without being associated a body supporting apparatus such as a chair and a bed, thereby saving a space it occupies.

To achieve the above objectives, the present invention provides a massage device comprising a supporting cover having a main body and a shoulder supporting member connected to the main body, the supporting cover being designed to be put on the human body by a belt; a shoulder massage part provided to the shoulder supporting member; and a driving part for driving and controlling the shoulder massage part.

The massage device may further comprise a power transmission part disposed between the shoulder massage part and the driving part to convert a rotational motion of the driving part into a linear reciprocal motion.

The power transmission part comprises a pinion supported by a pair of supporting blocks facing each other to receive the driving force from the motor, a rack reciprocating by the rotational force of the pinion, and a plurality of wires connected to a proximal end of the rack and extended out of the driving part.

A sensor is provided in the power transmission part to detect a pinion RPM, a detected signal being transmitted to the motor.

The supporting cover further comprises a neck supporting part formed on a top of the main body, the main body having left and right supporting members designed having a similar curvature to that of a specific body part on which they are to be put on, and the shoulder supporting member being mounted on the top of the main body at both sides of the neck supporting member by a hinge member.

The shoulder supporting member has an arc-shaped main body and longitudinal sidewalls formed on both sides of the main body to define a groove with the main body.

The shoulder massage part comprises a pair of supporting members disposed between the longitudinal sidewalls of the shoulder supporting member, a fixing member disposed between and fixed on the longitudinal sidewalls to slidably support the supporting members between the longitudinal side walls, and a shoulder massage members pivotally fixed on both ends of the supporting members by a pivot shaft.

Each of the shoulder massage members comprises a first pair of arms each having a first end fixed on the pivot shaft between the supporting members, a pressing member mounted on the second ends of the arms to perform the massage operation while contacting the human body, and a torsion spring for biasing the pressing members away from each other.

A massage time and a massage mode of the shoulder massage part are controlled by a control part.

The control part comprises a massage mode switch for selecting the massage mode.

The supporting cover further comprises a neck supporting part formed on a top of the main body, and a neck massage part formed in the neck supporting part.

The neck massage part comprises a pocket integrally formed with the neck supporting member, a supporting member movably disposed in the pocket, and a neck massage member hingedly fixed on the top of the supporting member by a fixing member.

An air bag is disposed between the neck supporting member and the supporting member so that the neck massage member performs its massage action in a state where the neck massage adheres closely to the neck.

The neck massage member is arc-shaped, and comprises a pair of arms, proximal ends of which are pivotally fixed each other by a fixing member, a pair of pressing members performing the massage operation while contacting the human body, and a torsion spring for biasing the arms to the widened position of the arms.

The pressing members moves toward each other and away from each other by a pivotal motion of the arms as a wire is pulled or released, thereby performing the massage operation.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 is an exploded perspective view of a massage device according to a preferred embodiment of the present invention;

FIG. 2 is an enlarged view illustrating a variety of assembled massage parts constituting a massage device according to a preferred embodiment the present invention;

FIG. 3 is a partly enlarged perspective view of a driving part and a power transmission part of a massage device according to a preferred embodiment of the present invention;

FIG. 4 is an enlarged perspective of a supporting cover of a massage device according to a preferred embodiment of the present invention;

FIG. 5 is a front view of FIG. 4;

FIG. 6 is a sectional view of a massage device mounted on the back according to a preferred embodiment of the present invention;

FIG. 7 is a partly exploded perspective view of a neck massage part of a massage device according to a preferred embodiment of the present invention;

FIG. 8 is a plane view of a neck massage part depicted in FIG. 7 when it is assembled;

FIG. 9 is an enlarged perspective view of a shoulder massage part of a massage device according to a preferred embodiment of the present invention; and

FIG. 10 is a side view of FIG. 9.

### DETAILED DESCRIPTION OF THE PREFERRED EMBODIMENTS

A preferred embodiment of the present invention will be described in detail with reference to the accompanying drawings.

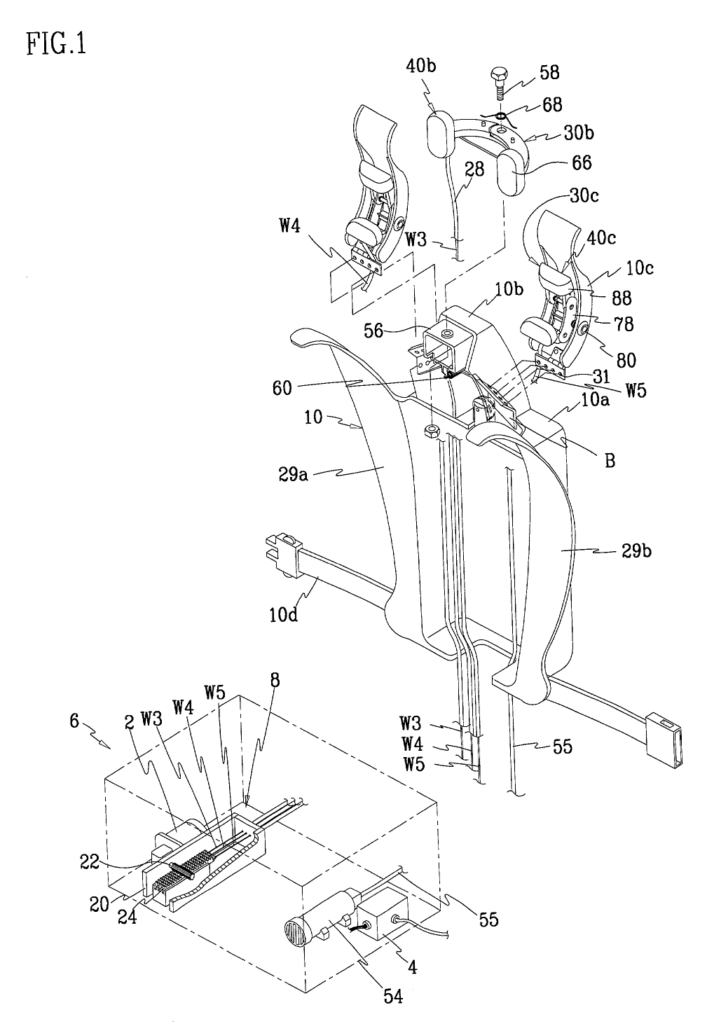

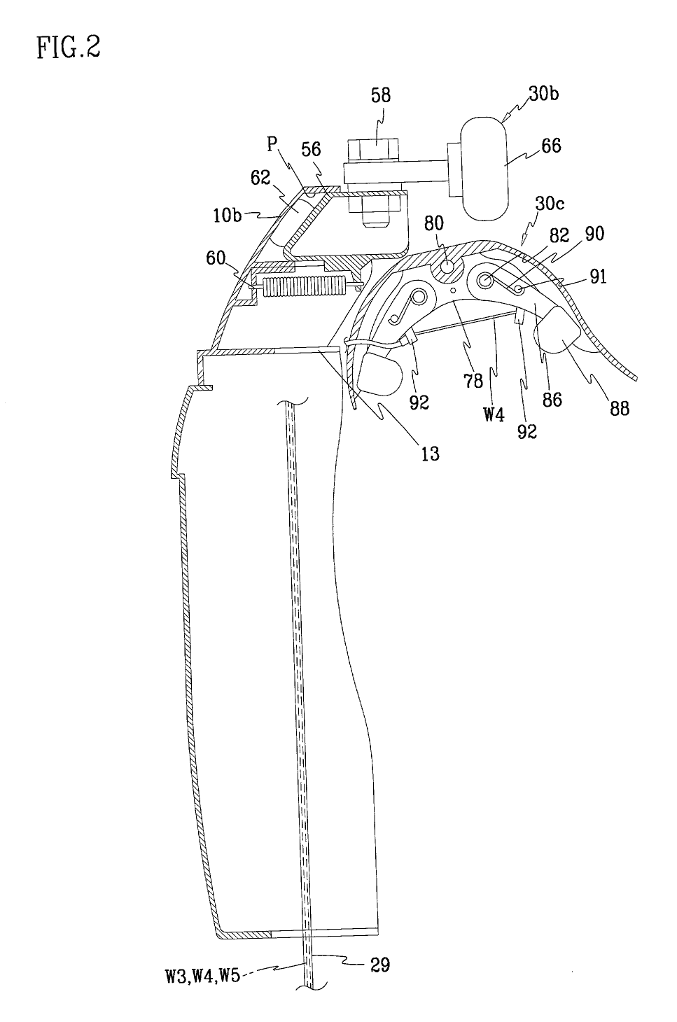

FIGS. 1, 2 and 3 show a massage device according to a preferred embodiment of the present invention.

Referring first to FIG. 1, the inventive massage device comprises a driving part 6 having a driving source such as a motor 2 and a controller 4 for controlling the operation of the motor 2; a power transmission part 8 for converting a rotational motion of the motor 2 into a linear reciprocal motion; a supporting cover 10 designed to be suitable to a human body so that it can put on the back of a user to be massaged; and a variety of massage means for massaging the shoulder, back or neck, the massage means being mounted on the supporting cover 10 and connected to the power transmission part 8.

The controller 4 controls a massage time and a variety of massage modes such as a stroking, rubbing and kneading modes.

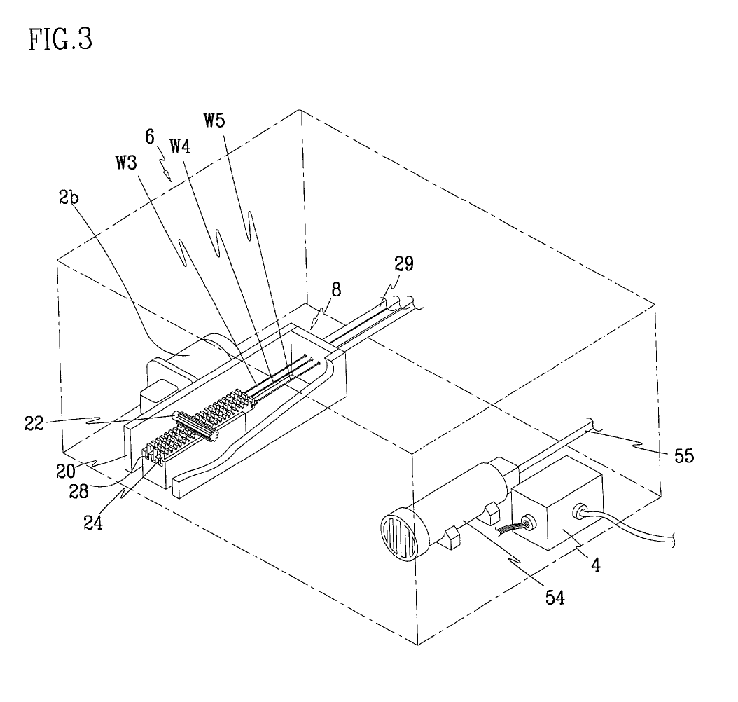

The power transmission part 8 transmits driving force created by the motor 2 to each massage means. As shown in FIG. 3, the power transmission part 8 comprises a pinion 22 receiving the driving fore from the motor 3, the pinion 22 being supported by a pair of supporting blocks 20 facing each other, a rack 24 engaged with the pinion 22 and reciprocating by the rotational force of the pinion 22, and a plurality of wires W3, W4 and W5 connected to a proximal end of the rack 24 and extended out of the driving part.

Mounted on one end of the pinion 22 is a sensor (not shown) for detecting the RPM of the pinion 22. A signal detected by the sensor is transmitted to the motor 2 via the controller 4 and controls the rotational direction and RPM of the pinion 22.

The rack 24 is designed to move along a guide member 28 disposed between the supporting blocks 20. Accordingly, the rack 24 pulls or releases the wires W3, W4 and W5 while linearly reciprocating according to the rotational direction of the pinion 22.

Preferably, portions of the wires W3, W4 and W5, which are disposed out of the power transmission part 8, are covered with protecting covers 29.

The above-described massage device is operated in a variety of modes according to the adjustment of a massage mode switch (not shown).

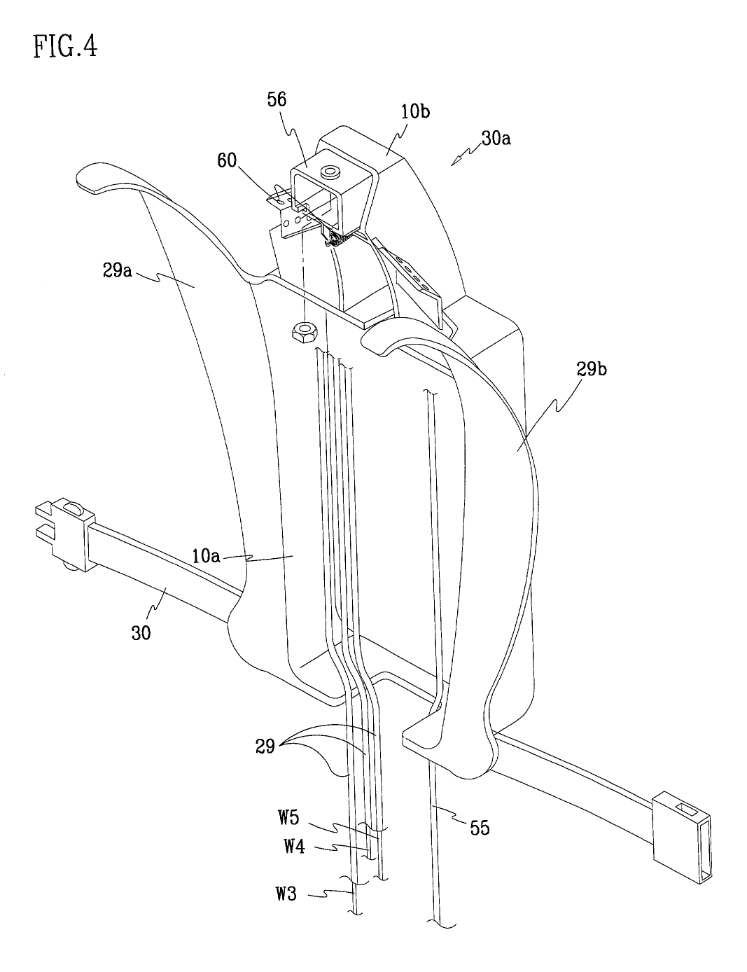

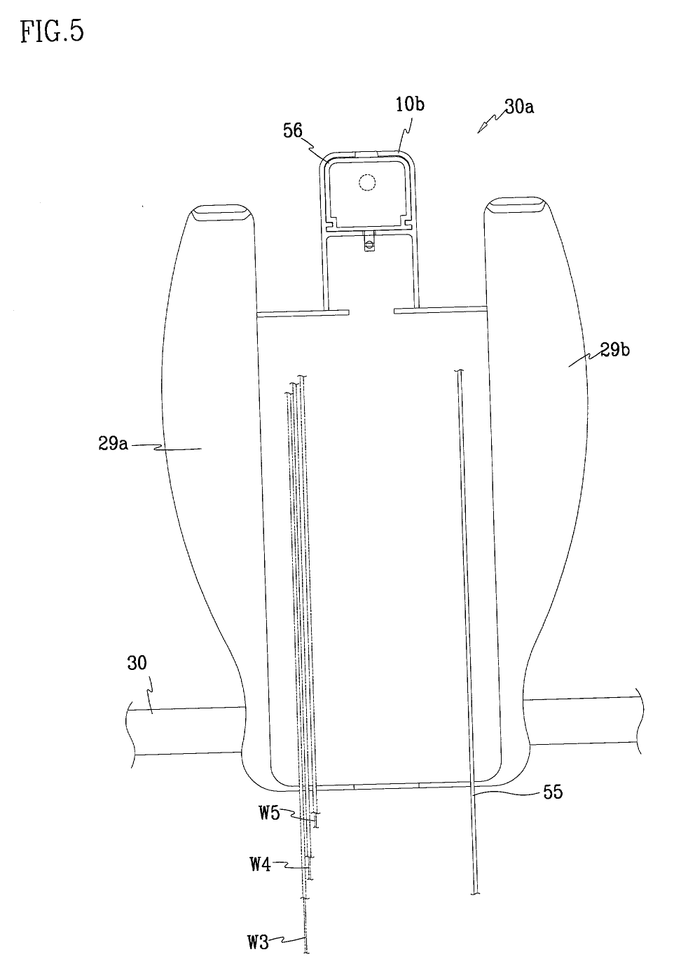

In addition, as shown in FIGS. 4 and 5, the supporting cover 10, in which the variety of massage means operated by the power transmission part 8 is mounted, comprises a main body 10a having left and right supporting members 29a and 29b designed having a similar curvature to that of a specific human body part on which they are to be put on, a neck supporting member 10b formed on the top of the main body 10a between the left and right supporting members 29a and 29b, and a pair of shoulder supporting members 10c (see FIG. 1) mounted on the top of the main body 10a at both sides of the neck supporting member 10b by hinge members 31.

Provided on both lower sides of the main body 10a is a waist belt 30 by which the main body 10a of the supporting cover 10 can be closely supported on the human body.

Preferably, a shoulder belt (not shown) may be further provided on the left and right supporting parts 29a and 29b.

The variety of massage means are mounted in the supporting cover 10. The variety of massage means comprise a neck massage part 30b installed in the neck supporting member 10b to massage the neck and a shoulder massage part 30c installed in the shoulder supporting members 10c to massage the shoulders.

The neck and shoulder massage parts 30b and 30c receive power from the motor 2 via the power transmission part 8.

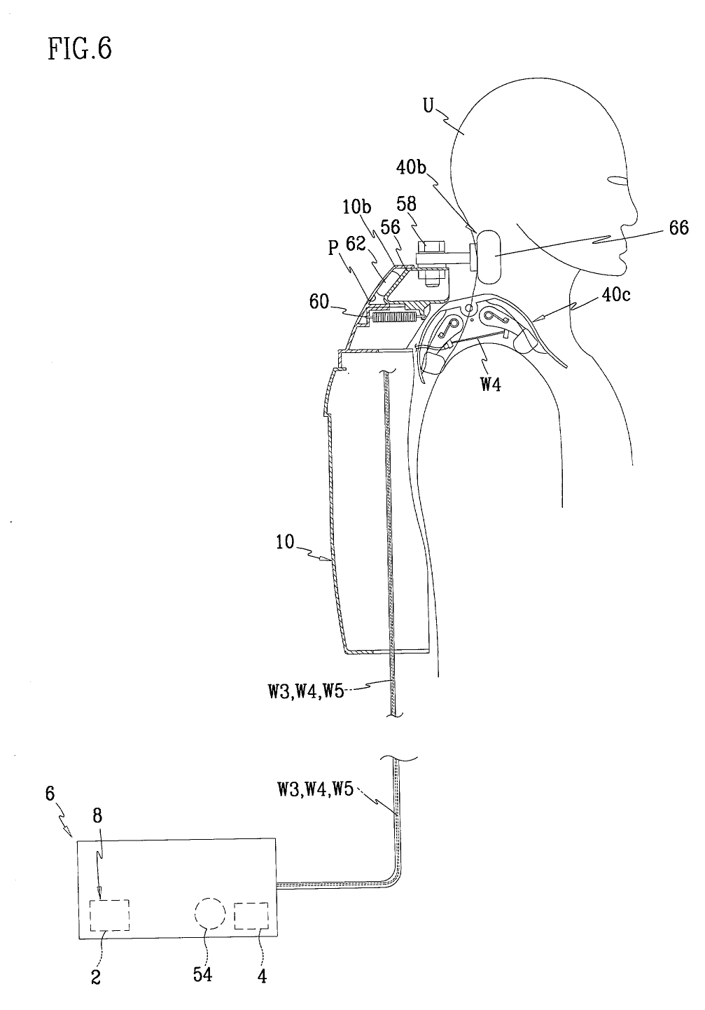

As shown in FIG. 6, the neck massage part 30b comprises a pocket P integrally formed with the neck supporting member 10b, a supporting member 56 movably disposed in the pocket P, a neck massage member 40b hingedly fixed on the top of the supporting member 56 by a fixing member 58, and an elastic member 60 disposed between the supporting member 56 and the neck supporting member 10b to bias the supporting member 56 toward the neck supporting member 10b.

In addition, disposed between the neck supporting member 10b and the supporting member 56 is an air bag 62 connected to an air injection member 54 through a tube 55 so that air can be injected into the air bag (see FIG. 1). By the air bag, the neck massage member performs its massage action in a state where it adheres closely to the neck.

As the air injection member 54, a small compressor generating compressed air may be used.

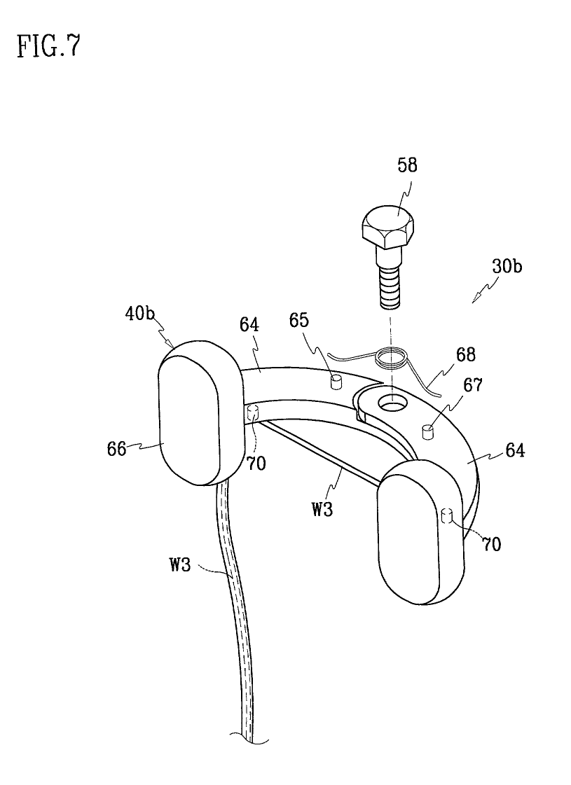

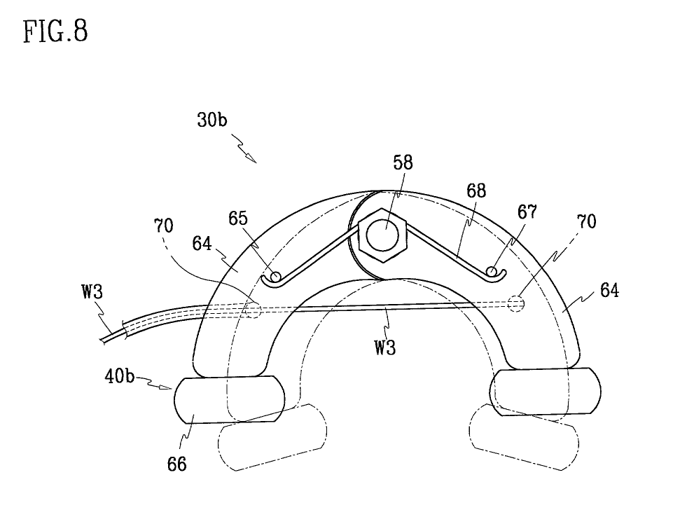

As shown in FIGS. 7 and 8, the neck massage member 40b is arc-shaped, and comprises a pair of arms 64, proximal ends of which are pivotally fixed each other by a fixing member 58, a pair of pressing members 66 performing the massage operation while contacting the human body, the pressing members 66 being mounted on distal ends of the arms 64, respectively, and a torsion spring 68 for biasing the arms 64 to the widened position of the arms 64.

The torsion spring 68 has a middle portion wound around the fixing member 58 and both ends elastically supported on projections 65 and 67 formed on the arms 64.

Supporting projections 70 are formed on bottoms of the both arms 64, respectively. One end of the wire W3 of the power transmission part 8 is hung on one of the supporting projections 70, and the other end of the wire W3 is hung on the other of the supporting projections 70.

In operation, when the motor is driven, the rotational motion of the motor 2 is converted into the linear reciprocal motion by the power transmission part 8 to pull or release the wire W3.

When the wire W3 is pulled by the power transmission part 8, the arms 64 move toward each other to knead the neck, and when the wire W3 is released, the arms 64 are widened from each other by the elastic force of the torsion spring 68. This operation is repeated as the motor 2 rotates forward and rearward.

In addition, the shoulder massage part 30c is provided on the left and right shoulder supporting members 10c. The left and right shoulder supporting members 10c is connected by the hinge members 31 to a bracket B fixed on the main body 10a (see FIG. 1).

Since both of the shoulder supporting members 10c has an identical structure to each other, only one of them will be described hereinafter.

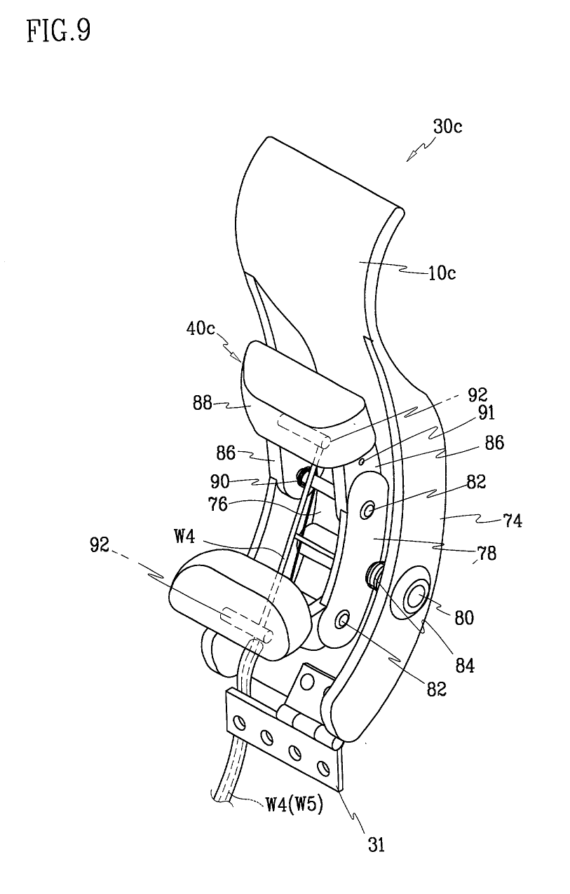

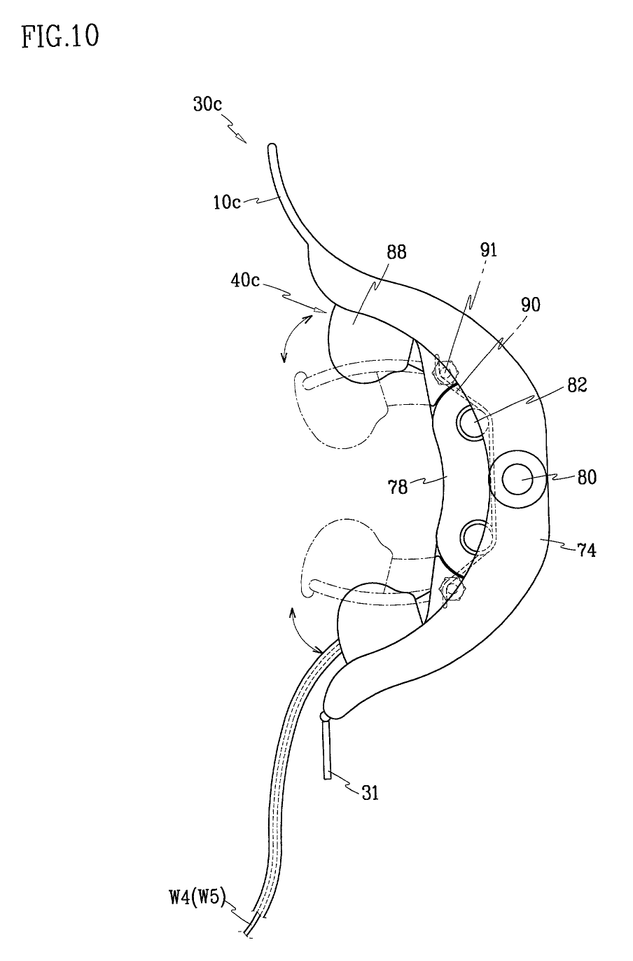

As shown in FIGS. 9 and 10, the shoulder supporting member 10c is arc-shaped to enclose shoulder. On both sides of the shoulder supporting member 10c, longitudinal sidewalls 74 are formed to define a groove 76 with the shoulder supporting member 10c.

The shoulder massage part 30c is installed in the groove 76 and supported by the longitudinal sidewalls 74. The shoulder massage part 30c comprises a pair of supporting members 78, a fixing member 80 disposed between and fixed on the longitudinal sidewalls 74 to slidably support the supporting members 78 between the longitudinal side walls 74, and shoulder massage members 40c pivotally fixed on both ends of the supporting members 78 by a pivot shaft 82.

Elastic members 84 are disposed between the longitudinal sidewalls and the supporting members 78.

Each of the shoulder massage members 40c comprises a first pair of arms 86 each having a first end fixed on the pivot shaft 82 between the supporting members 78, a pressing member 88 mounted on the second ends of the arms 86 to perform the massage operation while contacting the body, and a torsion spring 90 for widening the pressure members 78.

The torsion spring 90 has a first end fixed on the pivot shaft 82 and a second end fixed on a pin 91 formed on the arm 86 (see FIG. 10).

Disposed between the first pair of arms and between the second pair of arms are respectively a pair of fixing members 92. The wire W4 is wound around one of the fixing members 92, then extended and fixed to the other end of the fixing members 92.

When the motor 2 is driven, the wires W4 and W5 are pulled and released by the power transmission part 8 converting the rotational motion of the motor 2 into the linear reciprocal motion.

At this point, when the wires W4 and W5 are pulled, the first and second pairs of arms 86 move toward each other to knead the shoulders, and when the wires W4 and W5 are released, the first and second pairs of arms 86 move away from each. This operation is repeated as the motor 2 rotates forward and rearward.

In use of the above-described massage device, it is first put on the back, and then waist belt 30 and the shoulder belt (not shown) are properly fastened as shown in FIG. 6.

Next, the air injection member 54 is operated to inject air into the air bag 62 provided in the neck massage part 30b, thereby making the massage device contact the body.

After the massage device is completely put on the human body as described above, electric power is turned On to operate the motor 2, and a massage mode is selected by adjusting the massage mode switch (not shown) or the controller 4.

The driving force of the motor 2 is transmitted to the power transmission part 8, and is than converted into linear reciprocal motion. That is, the rotational motion of the motor 2 is transmitted to the pinion 22, and the rack 24 linearly moves along the pinion 22, thereby pulling or releasing the wires W3, W4, and W5. By this operation of the wires W3, W4 and W5, the neck massage member 40b and the left and right shoulder massage members 40c knead the neck and the shoulders while the arms 64 and 86 are moved toward each other or widened by the torsion springs 68 and 90.

To stop the massage operation, the electric power is turned Off, and the waist belt 30 and the should belt are released, after which the shoulder supporting member 10c is turned out, thereby removing the massage device from the body.

As described above, since the massage device is used in a state where it is put on the body, it is convenient to get the massotherapy, while saving a space.

While this invention has been described in connection with what is presently considered to be the most practical and preferred embodiments, it is to be understood that the invention is not limited to the disclosed embodiments, but, on the contrary, is intended to cover various modifications and equivalent arrangements included within the spirit and scope of the appended claims.

What is claimed is:

1. A massage device comprising:
a supporting cover having a main body and a shoulder supporting member connected to the main body, the supporting cover being designed to be put on the human body by a belt;
a shoulder massage part provided to the shoulder supporting member; and
a driving part for driving and controlling the shoulder massage part.

2. A massage device of claim 1 further comprising a power transmission part disposed between the shoulder massage part and the driving part to convert a rotational motion of the driving part into a linear reciprocal motion.

3. A massage device of claim 2 wherein the power transmission part comprises a pinion supported by a pair of supporting blocks facing each other to receive the driving force from the motor, a rack reciprocating by the rotational force of the pinion, and a plurality of wires connected to a proximal end of the rack and extended out of the driving part.

4. A massage device of claim 3 wherein a sensor is provided in the power transmission part to detect a pinion RPM, a detected signal being transmitted to the motor.

5. A massage device of claim 1 wherein the supporting cover further comprises a neck supporting part formed on a top of the main body, the main body having left and right supporting members designed having a similar curvature to that of a specific body part on which they are to be put on, and the shoulder supporting member being mounted on the top of the main body at both sides of the neck supporting member by a hinge member.

6. A massage device of claim 5 wherein the shoulder supporting member has an arc-shaped main body and longitudinal sidewalls formed on both sides of the main body to define a groove with the main body.

7. A massage device of claim 6 wherein the shoulder massage part comprises a pair of supporting members disposed between the longitudinal sidewalls of the shoulder supporting member, a fixing member disposed between and fixed on the longitudinal sidewalls to slidably support the supporting members between the longitudinal side walls, and a shoulder massage members pivotally fixed on both ends of the supporting members by a pivot shaft.

8. A massage device of claim 7 wherein each of the shoulder massage members comprises a first pair of arms each having a first end fixed on the pivot shaft between the supporting members, a pressing member mounted on the second ends of the arms to perform the massage operation while contacting the human body, and a torsion spring for biasing the pressing members away from each other.

9. A massage device of claim 1 wherein a massage time and a massage mode of the shoulder massage part are controlled by a control part.

10. A massage device of claim 9 wherein the control part comprises a massage mode switch for selecting the massage mode.

11. A massage device of claim 1 wherein the supporting cover further comprises a neck supporting part formed on a top of the main body, and a neck massage part formed in the neck supporting part.

12. A massage device of claim 11, the neck massage part comprises a pocket integrally formed with the neck supporting member, a supporting member movably disposed in the pocket, and a neck massage member hingedly fixed on the top of the supporting member by a fixing member.

13. A massage device of claim 12 wherein an air bag is disposed between the neck supporting member and the supporting member so that the neck massage member performs its massage action in a state where the neck massage adheres closely to the neck.

14. A massage device of claim 12 wherein the neck massage member is arc-shaped, and comprises a pair of arms, proximal ends of which are pivotally fixed each other by a fixing member, a pair of pressing members performing the massage operation while contacting the human body, and a torsion spring for biasing the arms to the widened position of the arms 64.

15. A massage device of claim 14 wherein the pressing members moves toward each other and away from each other by a pivotal motion of the arms as a wire is pulled or released, thereby performing the massage operation.
